(19) United States
(12) Patent Application Publication
(10) Pub. No.: US 2009/0236036 A1
(43) Pub. Date: Sep. 24, 2009

(54) HEAT CURABLE RESIN COMPOSITION, AND MOUNTING METHOD AND REPARING PROCESS FOR CIRCUIT BOARD USING THE HEAT CURABLE COMPOSITION

(76) Inventors: Hidenori Miyakawa, Osaka (JP); Ryou Kuwabara, Osaka (JP); Shigeaki Sakatani, Osaka (JP); Atsushi Yamaguchi, Osaka (JP); Susumu Saitoh, Osaka (JP); Arata Kishi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/306,610

(22) PCT Filed: Jun. 22, 2007
(86) PCT No.: PCT/JP2007/062608

§ 371 Date: Dec. 24, 2008

(30) Foreign Application Priority Data
Jun. 26, 2006 (JP) 2006-175323
Sep. 19, 2006 (JP) 2006-252420

(51) Int. Cl. B32B 38/10; C08L 63/00; B32B 38/00; B23K 31/02

(52) U.S. Cl. 156/247; 523/400; 523/457; 523/466; 228/176; 156/344

(57) ABSTRACT

A resin composition is provided that makes it possible to prevent low-heat resistant components from being damaged when heated in a process of mounting electronic components on a circuit board. There are also provided a method for easily repairing circuit boards that are determined to be off-specification products in the mounting process, and a method for separating and recovering useful circuit boards and/or electronic components from the circuit boards that are determined to be off-specification products in the mounting process. The resin composition comprises (A) 100 parts by weight of an epoxy resin, (B) 30 to 200 parts by weight of a thiol-based curing agent, (C) 5 to 200 parts by weight of an organic-inorganic composite insulating filler and (D) 0.5 to 20 parts by weight of an imidazole-based curing accelerator. According to the recovering method, the resin composition is softened by heating a part or whole of the circuit board in the mounting process, to a temperature in range not lower than the glass transition point of the resin composition and not higher than 110° C., and separating and recovering the electronic components from the circuit board.

### TECHNICAL FIELD

The present invention relates to a heat curable resin composition used to form a circuit board for electric apparatus. The present invention also relates to a method for mounting electronic components on the circuit board by using the heat curable resin composition.

The present invention further relates to a method for separating and recovering electronic components from the circuit board that is determined to be off-specification products in a circuit board mounting process. Moreover, the present invention relates also to an integrated circuit board mounting method that includes the circuit board mounting process for the production of electric apparatus, a recovery process for carrying-out the recovering method by using circuit boards which are sorted out and discharged from the mounting process, and a recycling process for recycling the circuit boards and/or electronic components that have been recovered in the recovering process.

### BACKGROUND ART

In recent years, as electronic apparatuses acquire higher performance, semiconductor electronic components and circuit boards are also required to be lower in profile and higher in packaging density. To meet these requirements, efforts have been made to decrease the size and improve the performance of electronic components such as chip components and CSP-packaged (chip-size packaged) IC, and decrease the wiring size by making the wiring with a narrower pitch on the circuit board. Thus the components are being mounted in increasingly higher density on the circuit boards. Accordingly, unit prices of the electronics components have been becoming higher as the degree of integration increases. Moreover, unit price of the circuit board having electronic components mounted thereon tends to increase as the added value thereof increases.

A method commonly employed to mount electronic components on the circuit board is to place the electronics components via a heat curable adhesive at predetermined positions of a circuit board, tentatively fasten the components on the circuit board by heating the adhesive to cure, apply a flux to the circuit board, and dip the circuit board in molten solder so as to establish electrical connections of the electronic components on the circuit board. For the heat curable adhesive used in mounting, an epoxy-based adhesive containing an amine-based curing agent having a curing temperature of about 150° C. or higher mixed therein is used.

However, there are electronic components that cannot tolerate a temperature of 150° C. or higher even for a short period of time, such as aluminum electrolytic capacitor and LED (hereinafter referred to as low-heat resistant components), and components of which tolerable temperatures have decreased due to size reduction as described above. As a result, there has been such a problem that such components may be damaged by heat in the process of curing the adhesive when an adhesive having curing temperature of about 150° C. is used as the heat curable adhesive for mounting.

Meanwhile in a process of assembling electric apparatuses in general, inspection and test (hereinafter collectively referred to as inspection) are made in a plurality of assembling stages so as to detect faulty products (or off-specification products), and off-specification products that have been detected are excluded from the assembling process. On the other hand, the products that have passed the inspection (on-specification products) are sent to the subsequent stage following the assembling process so as to be used in the production of the electric appliance.

The electronic components and the circuit board have high unit prices as described above. Therefore, when a circuit board having electronic components mounted thereon (hereinafter referred to also as mounting-completed circuit board) is determined to be off-specification products, discarding the mounting-completed circuit board as a whole leads to not only an increase in the cost of the final product but also to an increase in the volume of industrial waste, and is not desirable because it imposes burdens on the producer, consumers and the environment.

Mounting-completed circuit boards determined to be off-specification products include damaged electronic components that are damaged by various causes including exposure to heat, but also include electronic components that are simply mounted at wrong position and/or in wrong orientation on the circuit board, while the circuit board and/or the electronic components mounted thereon are not damaged and retain the required functions. Also in not a few cases, the circuit board can be reused by removing the off-specification electronics components. Such circuit boards and/or electronic components, when separated individually in an unharmful way, may be reused in mounting of the circuit board. Accordingly, it is desirable to separate and recover the circuit board and/or the electronic components that retain the required functions from the mounting-completed circuit board determined to be off-specification products, and reuse (so-called recycle) the circuit board and/or the electronic components that have been recovered, for the reduction of cost as well as to meet the demands of the present age such as resource saving and emission-free production.

For example, Patent Document 1 teaches a heat-separable adhesive composition aimed at recycling of recovered components by separating and recovering the components by heating a mounting-completed circuit board that has been assembled by curing a heat curable adhesive. The heat-separating adhesive composition has a property of beginning to swell when heated usually to a temperature of 150° C. or higher, preferably 200° C. or higher, and more preferably from 250 to 500° C.

Patent Document 2 teaches a method that uses a heat cutter for removing bare chips mounted on a circuit board. According to the present method, a cured adhesive is cut off with an edge of the cutter, while decomposing the adhesive by heating to a temperature higher than the curing temperature of the adhesive, for example about 300° C., by means of a heater incorporated in the cutter during the cutting operation.

### Patent Document 1: Japanese Unexamined Patent

### Publication (Kokai) No. 2000-204332

### Patent Document 2: Japanese Unexamined Patent

### Publication (Kokai) No. 06-5664

### DISCLOSURE OF THE INVENTION

### Problems to be Solved by the Invention

The heat-separating adhesive composition disclosed in Patent Document 1 utilizes a behavior of the adhesive composition that, after being cured, it can be removed from the circuit board and/or the electronic components by causing the cured adhesive to be swollen by heating the cured adhesive composition. In the process to remove the adhesive composition, it is necessary to heat the mounting-completed circuit board, which is subjected to the process of removing, to a temperature at which the thermal swelling begins (150° C.). Thus, it is necessary to heat the mounting-completed circuit board to a temperature of 150° C. or higher, preferably 200° C. or higher. As a result, the heat-separating adhesive composition disclosed in Patent Document 1 cannot be used in electric apparatuses and circuit boards that use low-heat resistant components.

The method disclosed in Patent Document 2 has a possibility of damaging the circuit board during the physical process of cutting operation. In addition, because the cutter is heated by the heater incorporated therein to a temperature higher than the curing temperature of the adhesive, for example about 300° C., the adhesive and the component are exposed to higher temperature via the cutter edge, which also poses the risk of damaging the electronics components. As a result, the method disclosed in Patent Document 2 cannot be used in such an application as electronic components that are low-heat resistant components unable to tolerate a temperature of 150° C. and the circuit board are to be separated without causing damage for the purpose of recycling.

In order to solve the problems described above, the present invention aims at providing a process of utilizing circuit boards and/or electronic components (hereinafter referred to also as components utilization process) that performs one or more of the following processes in combination:
(i) a process of excluding off-specification products (items that failed to satisfy predetermined specifications in inspection) detected in inspection from the producing process (or mounting process) and sending the off-specification products to a recovery process (or a repair process), at various stages of producing an electric apparatus;
(ii) a process of passing on-specification items (items that satisfied the predetermined specifications in inspection) through the predetermined producing process to complete the electric apparatus;
(iii) a process of separating individual electronic components and/or circuit boards from the off-specification products that have been excluded from any stage in the producing process in the process (i) described above and sent to a recovery process; and
(iv) a process of conducting the inspection as required on the individual circuit boards and/or the electronic components recovered in the process (iii), and returning useful (namely normal) circuit boards and/or electronic components to the producing process.

Hereinafter in the specification of the present application, removal of the electronic components from the mounting-completed circuit board will be referred to as repairing. Possibility to carry out predetermined treatment on the mounting-completed circuit board, whereon the electronic components are fastened by means of a resin composition, so as to separate and recover the circuit board and the electronic components without damaging will be referred to as repairability of the resin composition. Accordingly, one object of the invention of the present application is to provide a heat curable resin composition that has repairability useful for carrying-out the components utilization process described above. Another object of the present invention is to provide a method for separating and recovering (or method for repairing) the circuit board and the electronic components from the mounting-completed circuit board whereon the electronic components are fastened by means of a resin composition that has satisfactory repairability.

Still another object of the present invention is to provide a method for producing a circuit board that is an intermediate product made by tentatively fastening electronic components at predetermined positions thereon and can be sent to a flow soldering connection process when it is on-specification, or can be sent to the repairing process when it is off-specification products, for carrying-out the components utilization process described above.

A further object of the present invention is to provide a circuit board as an intermediate product that shows satisfactory repairability when it is off-specification products, or can be sent to the flow soldering connection process when it is on-specification.

A further object of the present invention is to provide a method for producing a circuit board that shows satisfactory repairability even when it is determined to be off-specification in the inspection conducted after the flow soldering connection process, for carrying-out the components utilization process described above.

A further object of the present invention is to provide a method for recycling those, among the circuit board and the electronic components that have been recovered by the method of separating and recovering the circuit board and the electronic components from the mounting-completed circuit board, that are useful to the electric appliance packaging process.

A further object of the present invention is to provide an integrated circuit board mounting method that includes the method for separating and recovering the circuit board and the electronic components from the mounting-completed circuit board and the method of recycling useful ones from the circuit boards and the electronic components that have been recovered to the electric appliance packaging process, for the purpose of effectively utilizing the components.

The present application, in a first aspect thereof, provides an invention of a heat curable resin composition comprising (A) 100 parts by weight of a liquid epoxy resin, (B) 30 to 200 parts by weight of a thiol-based curing agent, (C) 5 to 200 parts by weight of an organic-inorganic composite insulating filler and (D) 0.5 to 20 parts by weight of an imidazole-based curing accelerator, the heat curable resin composition having a curing temperature of 140° C. or lower.

The present application, in a second aspect thereof, provides an invention of a method for producing a circuit board having electronic components fastened at predetermined positions thereof to be subjected to flow soldering connection, comprising the processes of (i) supplying the resin composition according to claim 1 to the predetermined positions on the circuit board except for electrodes and placing the electronic components corresponding thereto, and (ii) fastening the electronic components on the circuit board by curing the resin composition through the application of temperatures up to 110° C.

The present application, in a third aspect thereof, provides an invention of a circuit board having electronic components mounted thereon, obtained by the method of the second invention.

The present application, in a fourth aspect thereof, provides an invention of a method for mounting electronic components on the circuit board by flow soldering connection, comprising the processes of (i) supplying the resin composition according to claim 1 to predetermined positions on the circuit board except for electrodes and placing the electronic components corresponding thereto, (ii) fastening the electronic components on the circuit board by curing the resin composition through the application of temperatures up to 110° C., and (iii) supplying the circuit board obtained in the process (iv) to a flow soldering connection line so as to complete the flow soldering connection.

The present application, in a fifth aspect thereof, provides an invention of a method for recovering circuit boards and electronic components, comprising softening a cured resin composition by heating a part or whole of mounting-completed circuit board, onto which circuit board several electronic components were fastened by means of the cured resin composition, to a temperature in a range not lower than the glass transition point of the resin composition and not higher than 110° C., thereby separating and recovering the electronic components from the circuit board. In the present specification, the method of recovering the circuit board and the electronic components will be referred to also as repairing process.

The present application, in a sixth aspect thereof, provides an invention of a method for recovering circuit board and electronic components from a mounting-completed circuit board having the electronic components fastened thereon by means of cured resin composition, which method comprises the processes of (a) softening the resin composition while heating the mounting-completed circuit board having the electronic components fastened thereon to a temperature in range from around the normal temperature to 110° C. or lower; (b) separating the electronic components from the circuit board by using a picking up tool; and (c) sending the circuit board obtained in the process (b) to a circuit board recovering process, and/or sending the electronic components separated in the process (b) to an electronic components recovering process.

The present application, in a seventh aspect thereof, provides an invention of a method for recycling useful ones among the circuit board and the electronic components recovered by the method of the first or second invention to an electric appliance packaging process.

The present application, in an eighth aspect thereof, provides an invention of an integrated method for mounting a circuit board, comprising (o) a circuit board mounting process that employs flow soldering connection; (p) a sorting process for sorting out circuit boards that are determined to be off-specification products by inspection in any stage of the mounting process and discharging the off-specification products from the mounting process; (q) a recovering process for carrying-out the first or second invention by using the circuit board discharged in the sorting process (p); and (r) a recycling process for applying the method of the third invention to the circuit board and/or electronic components recovered in the recovering process (q).

The inventions of the method for producing the circuit board, the circuit board, the method for mounting the electronic components on the circuit board, the method for recovering the electronic components and the circuit board, the method of recycling useful ones among the circuit boards and the electronic components that have been recovered to the electric appliance packaging process, and the integrated circuit board mounting method can be preferably implemented by using the heat curable resin composition according to the first aspect. There is no restriction on the resin composition as long as it has a glass transition point (Tg) of 20° C. or higher, preferably 30° C. or higher, more preferably 35° C. or higher and 105° C. or lower, preferably 100° C. or lower, and more preferably 80° C. or lower. However, the inventors of the present application conducted various experiments and found that curing and softening of the resin composition can be carried out in a controlled manner as described above, when an epoxy-based resin is used as the resin composition.

With respect to the heat curable resin composition, it is possible to use, as the liquid epoxy rein (A), compounds selected from the group consisting of bisphenol type epoxy resin, phenol novolak type epoxy resin, glycidyl ester type epoxy resin, glycidyl amine type epoxy resin, alicyclic epoxy resin and novolak type epoxy resin.

It is possible to use, as the thiol-based curing agent (B), compounds selected from the group consisting of mercaptpropionic acid derivatives such as 3-mercaptopropionic acid, methoxybutyl mercaptopropionate, octyl mercaptopropionate, tridecyl mercaptopropionate, trimethylolpropane tristhiopropionate and pentaerythritol tetrakisthiopropionate; or thioglycol derivatives such as pentaerythritol tetrakisthioglycolate, trimethylolpropane tristhioglycolate and butanediol bisthioglycolate.

It is possible to use, as the organic-inorganic composite insulating filler (C), compounds selected from the group consisting of those obtained by surface-treating inorganic fillers such as alumina, silica and talc with an organosilicone, organotitanium or organoaluminum compound.

It is possible to use, as the imidazole-based curing accelerator (D), include compounds selected from the group consisting of derivatives of 2-methylimidazole and 2-ethyl 4-methylimidazole, or a trimellitate or isocyanurate of the imidazole derivatives.

With respect to the system containing the above-mentioned components (A) to (D), when the amount of the thiol-based curing agent is less than 30 parts by weight, the curing temperature become 150° C. or higher and low-heat resistant parts may be deteriorated by heat during the curing process of the adhesive. In contrast, when the amount is more than 200 parts by weight, there arises a problem that storage stability of the adhesive becomes less than 30 days and the storage stability is insufficient as storage stability for practical use. Therefore, the amount of the thiol-based curing agent is preferably within a range from 30 to 200 parts by weight.

With respect to the system containing the above-mentioned components (A) to (D), when the amount of the organic-inorganic composite insulating filler is less than 5 parts by weight, there arises a problem that the viscosity of the adhesive becomes excessively low and the adhesive drops on a substrate during coating of the adhesive. In contrast, when the amount is more than 200 parts by weight, there can arise a problem on practical use that the viscosity of the adhesive becomes excessively high and it becomes impossible to smoothly coat the liquid adhesive using a coating device or means. Therefore, the amount of the organic-inorganic composite insulating filler is preferably within a range from 5 to 200 parts by weight.

With respect to the system containing the above-mentioned components (A) to (D), when the amount of the imidazole-based curing accelerator is less than 0.5 parts by weight, the curing temperature become 150° C. or higher and a low-heat resistant components may be deteriorated by heat during the curing process of the adhesive. In contrast, when the amount is more than 20 parts by weight, there arises a problem that storage stability of the adhesive becomes less than 30 days and the storage stability is insufficient as storage stability for practical use. Therefore, the amount of the imidazole-based curing accelerator is preferably within a range from 0.5. to 20 parts by weight.

As described above, the heat curable resin composition of the present invention can achieve the curing temperature of 140° C. or lower by preparing a heat curable resin composition according to the formulation containing 100 parts by weight of the epoxy resin (A), 30 to 200 parts by weight of the thiol-based curing agent (B), 5 to 200 parts by weight of the organic-inorganic composite insulating filler (C) and 0.5 to 20 parts by weight of the imidazole-based curing accelerator (D).

Furthermore, the above-mentioned formulation enables the heat curable resin composition of the present invention to have a glass transition point (Tg) within a range from 20 to 120° C., preferably from 30 to 100° C., and particularly from 35 to 80° C., after being once cured.

The heat curable resin composition has a liquid-like form before being applied to a circuit board. After the heat curable resin composition is applied to predetermined positions on the circuit board and electronic components are placed thereon, the heat curable resin composition is cured by being heated to a temperature of 110° C. or lower. After being cured, the resin composition has a property related to hardness of solid-like form or elastomer-like form to solid-like form. Such a property is useful for fastening the electronic components on the circuit board.

The circuit board having the electronic components mounted thereon by using the resin composition of the present invention is, when failed to pass the inspection, discharged from the assembling line and sent to the repairing process. The circuit board sent to the repairing process is heated from around the normal temperature to a temperature around 100° C. As a result, the cured resin composition that has the glass transition point of 100° C. or lower, preferably of between 35° C. and 80° C. may be softened. For the heating means used in this repairing process, various means known to those skilled in the art such as conveyor means that passes through a heating zone, warm air blower or soldering iron may be used as long as it can heat the circuit board, electronic components and/or resin component to a temperature up to 100° C.

Then, the softened resin composition has a lowered physical strength than that of the cured state thereof having the hardness of solid-like form or elastomer-like form. Thus, the softened resin composition can be handled as a material that shows ordinary viscoelasticity, for example a high polymer compound of gel state. As a result, the softened resin composition can be easily broken or torn off by holding the electronic component with a proper fixture such as tweezers or cutting pliers and lifting the electronic component either mechanically or by hand. In this way one or more particular electronic components can be separated from the circuit board and recovered.

The inspection may be conducted before sending the circuit board having the electronic components fastened thereon to the flow soldering connection process, but may also be conducted after flow soldering connection of the circuit board having the electronic components mounted thereon. In the inspection conducted before sending the items to the flow soldering connection process, it is checked mainly to determined whether positions and orientations of the electronic components fastened on the circuit board are correct or not, which may be carried out visually by a human operator, but also can be carried out automatically by an apparatus having a pattern recognition program and the like. In the inspection conducted after flow soldering connection, it is checked mainly to determine whether the mounting-completed circuit board shows predetermined electrical characteristics or not, by using a test facility, since mounting of the circuit board has been tentatively completed by the time of this stage. These inspections are carried out as required in accordance to the type of electric appliance to be assembled. In case the heat curable resin composition of the present invention is used, the circuit board and the electronic components can exhibit good repairability in the inspection conducted either before or after the flow soldering connection process.

Thus the heat curable resin composition of the present invention is useful for an application in which the electronic components are tentatively fastened on the circuit board during the producing process. The circuit board obtained by tentatively fastening the electronic components on the circuit board may be sent to either the repairing process or the subsequent producing process, as an intermediate product in the producing process of the electric apparatus.

When the circuit board being subjected to the flow soldering connection is sent to the separating process, soldering connections between the circuit board and the electronic components can be broken by heating the solder connections by using a proper tool so as to melt the solder before heating to the softening temperature or simultaneously therewith.

When carrying-out the invention of the present application described above, it is preferable that the resin composition that fastens the electronic components on the circuit board has good repairability. With regard to the invention of the present application, in case the resin composition has good repairability, the resin composition can be changed from a cured form in which the resin composition is in a glassy phase (glass transition region) to a softened form in which the resin composition shows rubbery phase elasticity (rubber-like elasticity region), as the resin composition in cured state is heated from around the normal temperature to a temperature not higher than 110° C., preferably a temperature not higher than 105° C. and more preferably a temperature not higher than 100° C. As a result, the circuit board and the electronic components can be recovered without damaging low-heat resistant components and/or the circuit board by breaking the softened resin composition.

With regard to the invention of the present application, the glass transition region refers to a region which shows a level not higher than the glass transition point (Tg) according to measurements of the dynamic viscoelasticity (DMA). The softened state having rubber-like elasticity means a state where storage elastic modulus is in a range from 10 MPa to 1,000 MPa.

Thus any of the methods of the first through fourth inventions of the present application can be effectively implemented when components are mounted on the circuit board by using a resin composition that shows dynamic viscoelasticity measurement in the glass-like region at around the normal temperature in cured state, and softens when heated to temperature of 110° C. or lower so as to show storage elastic modulus in a range from 10 MPa to 1,000 MPa.

In case the resin composition shows such characteristics as described above, the softened resin composition that shows relatively soft rubber-like elasticity can be obtained by carrying-out the method for recovering a circuit board and electronic components by heating a part or whole of the mounting-completed circuit board, onto which circuit board several electronic components are fastened by cured resin composition, to a temperature in a range not lower than the glass transition point and not higher than 110° C. so as to soften the resin composition, and separating and recovering the electronic components from the circuit board. The resin composition can be easily broken while holding the electronic components with the picking up tool, by holding the electronic component with a proper fixture such as tweezers and lifting the electronic component in this state. As a result, it is made possible to remove the resin composition and separating circuit board and/or electronic components from each other relatively easily without thermally or physically damaging the circuit board and/or electronic components.

Similarly, in case the resin composition shows such characteristics as described above, the softened resin composition shows relatively soft rubber-like elasticity, when the method for recovering the circuit board and the electronic components from the mounting-completed circuit board that has the electronic components fastened thereon by means of the cured resin composition is implemented, comprising the processes of (a) softening the resin composition while heating the mounting-completed circuit board having the electronic components fastened thereon in a temperature range from around the normal temperature to 110° C. or lower; (b) separating the electronic components from the circuit board by using a picking up tool; and (c) sending the circuit board obtained in the process (b) to the circuit board recovering process and/or sending the electronic components separated in the process (b) to an electronic components recovering process. The resin composition can be easily broken while holding the electronic components with the picking up tool, by holding the electronic component with a proper fixture such as tweezers and lifting the electronic component in this state. As a result, it is made possible to remove the resin composition and separate the circuit board and the electronic components from each other relatively easily without thermally or physically damaging the circuit board and the electronic components.

Similarly, in case the resin composition shows such characteristics as described above, it is made possible to effectively implement the integrated circuit board mounting method that includes (o) the circuit board mounting process that employs flow soldering connection; (p) a sorting process for sorting out circuit boards determined to be off-specification by inspection in any process of the mounting process and discharging the off-specification products from the mounting process; (q) a recovering process for carrying-out the first or second invention by using the circuit board discharge in the sorting process (p); and (r) a recycling process for applying the method of the third invention to the circuit board and/or the electronic components recovered in the recovering process (q).

The integrated circuit board mounting method is characterized in that a stream related to the production of items where the mounting process (o) of mounting the components on the circuit board by the flow soldering connection is carried out, and a stream related to recovering of useful items, where the process (p) of recovering useful circuit board and/or electronic components from off-specification products produced in the mounting process is carried out, are conducted in combination. The circuit board and/or the electronic components that have-been recovered are recycled to the mounting process (o) so as to avoid wasteful disposal of the circuit board and the electronic components, thus aiming at efficient utilization of the circuit board and the electronic components at a practical level.

An example of the invention of the integrated circuit board mounting method of the present application is shown in a schematic flow chart of FIG. 2.

The circuit board mounting process (will be referred to also as mounting process (o)) that uses the flow soldering connection proceeds sequentially from top to bottom on the left-hand side of FIG. 2, namely from process S1 of applying the resin composition, process S2 of placing the components, heat-curing process S3, flow soldering process S4 and to assembling finishing process S5, and is referred to also as production-related stream in the present application.

The sorting process (will also be referred to as sorting process (p)) that sorts out circuit boards that are determined to be off-specification products in the inspection and discharges it from the mounting process in any stage of the of the mounting process (o) is represented as inspection processes E1 and E2 provided in the course of the mounting process (o). The inspection processes E1 and E2 can be implemented in any of three ways of carrying-out E1 while passing (omitting) E2, carrying-out E2 while passing E1 and carrying-out both processes of E1 and E2.

The recovering process (will also be referred to as recovering process (q)) where the method of the first or second invention is implemented by using the circuit board discharged by the sorting process (p) is represented in FIG. 2 by the stream from the inspection process E1 to the repairing process R1 following transfer along line NG on the right-hand side, to the inspection process E3 and the stream from the inspection process E2 to the repairing process R2 following transfer along line NG on the right-hand side to the inspection process E4.

The recycling process (will also be referred to as recycle (r)) that applies the method of the third invention to the circuit board and/or the electronic components that are recovered in the recovering process (q) is represented in FIG. 2 by a recycling line RL1 running from the inspection process E3 downward then to the right along line OK, and then upward, bending to the left so as to be sent to the process S2, and a recycling line RL2 that starts at the inspection process E4, runs downward then to the right along line OK, and then upward so as to join the recycling line RL1.

### EFFECT OF THE INVENTION

The heat curable resin composition according to the present invention, due to having the composition described previously, makes it possible to mount electronic components on the circuit board while avoiding heating of the circuit board and the electronic components to a temperature exceeding 140° C. As a result, the electronic components can be mounted on the circuit board without causing deterioration of performance or damage of the electronic components even when low-heat resistant components are used. In case the mounting-completed circuit board is subjected to the repairing process that follows, the resin composition can be softened by heating to a temperature not lower than the glass transition point and not higher than 110° C. As a result, the repairing process can be carried out at a relatively low temperature of 110° C., and the circuit board and/or the electronic components can be recovered intact in the repairing process.

According to the method of the present invention for producing the circuit board having the electronic components fastened at predetermined positions, the circuit board and/or the electronic components that are not faulty can be recovered and the circuit board and/or the electronic components that are recovered can be returned to the producing process by sending the components to the producing process, even when they fail to pass the inspection conducted before the flow soldering connection. Therefore the method is useful for assisting the utilization process for components. The circuit boards obtained by this method also contribute to the effective implementation of the utilization process for components.

According to the method of mounting the electronic components on the circuit board by flow soldering connection, circuit boards and/or electronic components that are not faulty can be recovered and the recovered circuit board and/or the electronic components can be returned to the producing process by sending the components to the repairing process even when they fail to pass the inspection. Therefore the method is useful for assisting the utilization process for components. The circuit boards obtained by this method also contribute to the effective implementation of the utilization process for components.

According to the invention of the method of recovering electronic components provided by the present application, in case the resin composition that fastens the electronic components on the circuit board in the cured state can be softened by heating to a temperature not lower than the glass transition point and not higher than 110° C., it is made possible to select whether to fasten the electronic components on the circuit board by making use of the properties of the resin composition or to separate the electronic components from the mounting-completed circuit board and recover (namely remove) the electronic components (Repairing processes R1 and R2).

According to the invention of another method of recovering electronic components provided by the present application, in case the resin composition that fastens the electronic components on the circuit board in the cured state can be softened by heating to a temperature not lower than the glass transition point and not higher than 110° C., it is made possible to select whether to separate the electronic components from the mounting-completed circuit board or to send the circuit board and/or the electronic components that have been separated and recovered and send them to the respective recovering processes (Repairing processes R1 and R2).

Further according to the invention of the integrated circuit board mounting method provided by the present application, the stream of one major item that is the mounting process (o) of mounting components on the circuit board by the flow soldering connection (production-related stream), and the stream of another major item that is the process (p) of recovering useful circuit boards and/or electronic components from off-specification products produced in the mounting process (o) (recovery-related stream) are implemented while being related to each other, so as to recycle the circuit board and/or the electronic components that have been recovered in the process (p) to the mounting process (o), thereby making maximum use of the circuit board and the electronic components (FIG. 2).

Thus according to the invention of an integrated method of mounting a circuit board provided by the present application, the process of producing electric appliances having a main purpose to improve productivity, particularly through correlating the production-related stream involved in the process (o) of mounting the components on the circuit board to the recovery-related stream involved in the process (p) where useful circuit boards and/or electronic components are recovered from off-specification products produced in the mounting process (o) at several steps by applying an appropriate treatment to the items in one stream and transferring the items to an optimum stage in another stream, may be effectively utilized at a practical level and may be avoid unprofitable disposal of the circuit board and the electronic components.

### BRIEF DESCRIPTION OF THE DRAWINGS

FIG. 1 is a schematic diagram showing the process of mounting electronic components on a circuit board by using the heat curable resin composition of the present invention.

FIG. 2 is a flow chart schematically explaining the integrated method for mounting a circuit board of the present invention.

### DESCRIPTION OF REFERENCE NUMERALS

1: Circuit board

2: On-board electrode

3: Heat curable resin composition

4: Electronic component

5: Cured resin composition

6: Flux

7: Solder

S1: Applying resin composition

S2: Placing Components

S3: Heating and Curing

S4: Flow Soldering

S5: Assembling Finishing process

E1, E2, E3, E4: Inspection process

R1, R2: Repairing process

NG: Flow of off-specification items

OK: Flow of on-specification items

RL1, RL2: Components and/or Circuit Board Recycling Line

The respective inventions of the present application will now be described by way of preferred embodiments.

### (Heat Curable Resin Composition)

Using the below-mentioned components as components (A) to (D), heat curable resin compositions of the respective Examples and Comparative Examples shown in Table 1 were prepared.

### Component (A)

Epoxy resin a: EPICOAT 828 (manufactured by Japan Epoxy Resins Co., Ltd.), (Bisphenol A type epoxy resin having an epoxy equivalent of 187).

### Component (B)

Curing agent a: Trimethylolpropane tristhiopropionate (manufactured by Yodo Kagaku Co., Ltd.)

Curing agent b: AMICURE NY10 (manufactured by Ajinomoto Fine-Techno Co., Inc.) (Amine adduct-based curing agent).

Curing agent C: RIKASID MH (manufactured by New Japan Chemical Co., Ltd., melting point: 22° C., acid anhydride-based curing agent).

### Component (C)

Organic-inorganic composite insulating filler: AEROSIL 200 (manufactured by NIPPON AEROSIL CO., LTD.).

### Component (D)

Curing accelerator: Curezol 2MZA (manufactured by Shikoku Chemicals Corporation).

These components were mixed according to predetermine formulation shown in Table 1 and then sufficiently kneaded to obtain a uniform uncured resin composition having proper fluidity suited for use in mass production, as well known in persons skilled in the art. Means and devices used for kneading are some means and devices which are well known person skilled in the art.

The following respective characteristics of the resulting resin compositions were examined. Procedures for measuring the respective characteristics are as follows. The results are shown in Table 2.

DSC Reaction Peak Temperature: Using a differential scanning thermal analysis equipment (manufactured by Seiko Nanotechnology Co., Ltd.), a heat curable resin composition was heated at a rate of 10° C./minute and the temperature at which maximum heat generation of a curing reaction is observed is taken as a DSC reaction peak temperature [° C.].
Storage Stability: Viscosity NO of a resin composition immediately after preparation is measured by an E type viscometer. Furthermore, the resin composition is stored in a constant-temperature bath at 10 plus/minus 1° C. and viscosity N1 is periodically measured every predetermined time (for example, one day). Based on the experience of the present inventors' studies for a long year, in the field of mounting, storage stable day of 180 or more is taken as an indicator suited for practical use. Therefore, it was recognized that an example showing a storage stability day of 180 days or more has a practicable storage stability day of 180 days or more.
Coating stability: A resin composition was set to an adhesive applicator (Panasert HDP) and allowed to stand for 10 minutes and then the application operation is performed. After standing for 10 minutes, the case where the resin composition was dropped through an application nozzle was evaluated as “No Good (NG).” After standing for 10 minutes, when dropping of the resin composition through the application nozzle does not occur, the application operation is performed. The case where the resin composition was not ejected through an application nozzle after performing the application operation was evaluated as “NG.” Examples other than these two NG cases (which may be referred to as “no NG”) are recognized that they show good coating stability suited for practical use, and are indicated by the symbol “Good (G)” in Table 2.
Glass Transition Point (Tg): Using a dynamic viscoelasticity measuring equipment (manufactured by Seiko Instruments Inc.), a cured article of a heat curable resin composition was heated at a rate of 10° C./minute and the temperature at which maximum decrement (tan δ) is observed is taken as a glass transition point Tg [° C.].

Faulty component ratio: The heat curable resin composition is applied to the circuit board with an applicator, tubular aluminum electrolytic capacitors (tolerable temperature 150° C.) are mounted by a part mounter, the heat curable resin composition is heated to cure in a heating furnace in such a thermal profile that completely cures each heat curable resin composition, and the number a of damaged components among the components at 100 positions is counted, to calculate faulty component ratio (%) as (a/100)×100.

Low-heat resistant component failure ratio: The heat curable resin composition is applied to the circuit board by an applicator, LEDs (tolerable temperature 110° C.) are mounted by a part mounter, the heat curable resin composition is heated to cure in a heating furnace in such a thermal profile that completely cures each of the heat curable resin composition, and the number b of damaged components among the components at 100 positions is counted, to calculate low-heat resistant component failure ratio (M) as (b/100)×100.

Faulty board ratio in repair: The heat curable resin composition is applied to the circuit board with an applicator, packaged IC is mounted by a part mounter, the heat curable resin composition is heated to cure in a heating furnace in such a thermal profile that completely cures each of the heat curable resin composition, a flux is applied, the circuit board is dipped in molten solder for soldering and cooled down to the room temperature, a soldering iron is locally put into contact with the points of soldering connection to melt the solder while removing the molten solder with a copper braid, the heat curable resin composition between the packaged IC and the circuit board is heated to the glass transition point of the resin composition, the packaged IC is removed from the circuit board while the resin composition is softened, and the number c of faults of the resist among 100 positions of the circuit board from which the components have been removed is counted, to calculate the faulty board ratio as (c/100)×100.

TABLE 1

| | Example | Example | Example | Example | Example | Example | Example |
|---|---|---|---|---|---|---|---|
| | 1 | 2 | 3 | 4 | 5 | 6 | 7 |
| Epoxy resin | 100 | 100 | 100 | 100 | 100 | 100 | 100 |
| Curing agent a | 100 | 35 | 190 | 100 | 100 | 100 | 100 |
| Curing agent b | | | | | | | |
| Curing agent c | | | | | | | |
| Organic- | 30 | 30 | 30 | 7 | 190 | 30 | 30 |
| inorganic | | | | | | | |
| composite filler | | | | | | | |
| Curing | 1 | 1 | 1 | 1 | 1 | 0.6 | 18 |
| accelerator | | | | | | | |

| | Compar- | Compar- | Compar- | Compar- | Compar- | Compar- | Compar- | Compar- |
|---|---|---|---|---|---|---|---|---|
| | ative | ative | ative | ative | ative | ative | ative | ative |
| | Example | Example | Example | Example | Example | Example | Example | Example |
| | 1 | 2 | 3 | 4 | 5 | 6 | 7 | 8 |
| Epoxy resin | 100 | 100 | 100 | 100 | 100 | 100 | 100 | 100 |
| Curing agent a | | | 25 | 210 | 100 | 100 | | |
| Curing agent b | 20 | | | | | | | |
| Curing agent c | | 100 | | | | | | |
| Organic- | 30 | 30 | 30 | | 4 | 210 | | |
| inorganic | | | | | | | | |
| composite filler | | | | | | | | |
| Curing | | | | | 0.4 | | 0.4 | 21 |
| accelerator | | | | | | | | |

(Numerals are based on parts by weight.)

TABLE 2

| | Example | Example | Example | Example | Example | Example | Example |
|---|---|---|---|---|---|---|---|
| | 1 | 2 | 3 | 4 | 5 | 6 | 7 |
| DSC reaction peak | 83 | 109 | 79 | 79 | 101 | 100 | 77 |
| temperature (° C.) | | | | | | | |
| Storage stability | 180 days | 180 days | 180 days | 180 days | 180 days | 180 days | 180 days |
| (day) | or more | or more | or more | or more | or more | or more | or more |
| Coating stability | G | G | G | G | G | G | G |
| Faulty component | 0 | 0 | 0 | 0 | 0 | 0 | 0 |
| ratio (%) | | | | | | | |
| Low-heat resistant | 0 | 0 | 0 | 0 | 0 | 0 | 0 |
| component failure | | | | | | | |
| ratio (%) | | | | | | | |

| | Compara- | Compara- | Compara- | Compara- | Compara- | Compara- | Compara- | Compara- |
|---|---|---|---|---|---|---|---|---|
| | tive | tive | tive | tive | tive | tive | tive | tive |
| | Example | Example | Example | Example | Example | Example | Example | Example |
| | 1 | 2 | 3 | 4 | 5 | 6 | 7 | 8 |
| DSC reaction peak | 151 | 160 | 173 | 130 | 77 | 104 | 133 | 58 |
| temperature (° C.) | | | | | | | | |
| Storage stability | 180 days | 180 days | 180 days | 7 days | 180 days | 180 days | 180 days | 2 days |
| (day) | or more | or more | or more | | or more | or more | or more | |
| Coating stability | G | G | G | G | NG | NG | G | G |
| Faulty component | 5 | 22 | 59 | 0 | 0 | 0 | 0 | 0 |
| ratio (%) | | | | | | | | |
| Low-heat resistant | 100 | 100 | 100 | 0 | 0 | 0 | 80 | 0 |
| component failure | | | | | | | | |
| ratio (%) | | | | | | | | |

With the material of Example 1 where curing agent a (thiol-based curing agent) was used, the resin composition could be cured without damaging the components with a DSC reaction peak temperature being 83° C. and the faulty part ratio being 0%. With regard to the low-heat resistant component failure ratio analyzed by using LEDs, faulty components were found at a ratio as low as 1%.

With the material of Example 2 where proportion of the curing agent was decreased, the DSC reaction peak temperature rose to 109° C., although the faulty part ratio remained at 0%, and the resin composition could be cured without damaging the components. The low-heat resistant component failure ratio analyzed by using LEDs was 0%, and no faulty components were found.

With the material of Comparative Example 1 where curing agent b (amine-based curing agent) was used, DSC reaction peak temperature was 151° C. and faulty part ratio was 5%, and components were damaged during thermal curing. With regard to low-heat resistant component failure ratio, faulty components were found at a ratio of 100%.

With the material of Comparative Example 2 where curing agent c (anhydride-based curing agent) was used, DSC reaction peak temperature was 160° C. and faulty part ratio was 22% and components were damaged during thermal curing. With regard to low-heat resistant component failure ratio, faulty components were found at a ratio of 100%.

As is apparent from the above results, when the thio-based curing agent is used, the DSC reaction peak temperature of the resin composition can be relatively decreased when compared with the case of using the amine-based curing agent a or acid anhydride curing agent c, and also the curing temperature can be-relatively decreased when the heat curable resin composition is prepared.

The low-heat resistant component failure ratio remained at 0% with any of the resin compositions of Examples 1 through 7, and this value is far lower compared to the low-heat resistant component failure ratio of 100% in the case of using the resin compositions of Comparative Examples 1 and 2. Thus it was found that practical level of damage preventing effect can be achieved by using the resin composition of Example when mounting LED low-heat resistant component having tolerable temperature of 110° C. Moreover, when the material of Example with imidazole-based curing accelerator added thereto is used, excellent low-heat resistant component failure ratio of 0% is obtained.

As a result of consideration of above results, it is considered that use of the thiol-based curing agent as the curing agent of the epoxy-based resin composition is effective for decreasing the curing temperature of the resin composition and that the addition of the imidazole-based curing agent to the composition is effective for further decreasing the curing temperature of the resin composition.

As described above, the present inventors have already confirmed that a heat curable resin composition with the formulation containing 100 parts by weight of the epoxy resin (A), 30 to 200 parts by weight of the thiol-based curing agent (B), 5 to 200 parts by weight of the organic-inorganic composite insulating filler (C) and 0.5 to 20 parts by weight of the imidazole-based curing accelerator (D) can have a glass transition temperature (Tg) of 20° C. or higher, preferably 30° C. or higher, particularly preferably 35° C. or higher, and 105° C. or lower, preferably 100° C. or lower, particularly preferably 80° C. or lower, and thus it is a resin composition which exhibits good repairability with respect to the present invention.

Before being applied to a circuit board, the heat curable resin composition has liquid form and may be supplied to predetermined positions on the circuit board. After electronic components are placed onto the corresponding positions of the heat curable resin composition, the circuit board is heated. Then, the heat curable resin composition cures before the temperature reaches 110° C. After being cured, the resin composition has a property related to hardness of solid-like form or elastomer-like form to solid-like form. Such a property is useful for fastening the electronic components on the circuit board.

The heat curable resin composition having the composition described above is useful for mounting the electronic components on the circuit board while preventing the circuit board and the electronic components from being heated to a temperature beyond 140° C. also when fastening the electronic components on the circuit board. As a result, it is made possible to mount the electronic components on the circuit board without deteriorating or damaging the functions of the electronic components even when low-heat resistant components are used, and the circuit board and/or the electronic components can be recovered substantially intact without causing physical or thermal damage to the circuit board and/or the electronic components, also when the method of the present invention is applied thereafter to a circuit board having the electronic components mounted thereon.

### Mounting Process

Now the method of mounting the electronic components on the circuit board by using the heat curable resin composition of the present invention will be described with reference to the accompanying drawings.

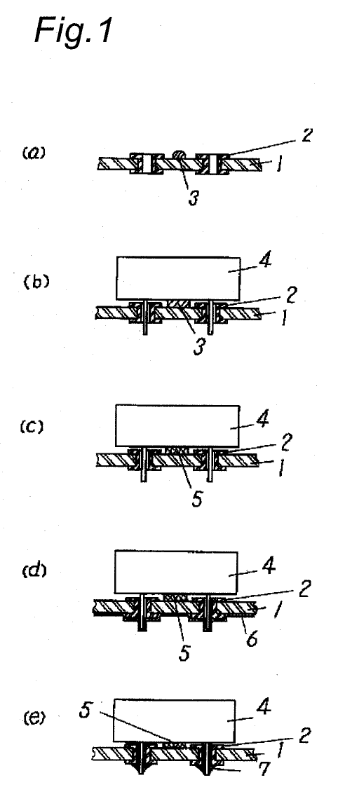

As shown in FIG. 1(a), a circuit board 1 has on-board electrodes 2 and through holes formed therein for inserting leads of the electronic components mounted corresponding thereto. An appropriate quantity of the heat curable resin composition of the present invention is supplied to the area where the circuit board 1 except for the electrodes and the main body of the electronic components (the portion except for terminals and/or leads) overlap each other, when viewed from above the circuit board 1. Thus the resin composition of the present invention is supplied to the predetermined area of the circuit board except for the electrodes. Then as shown in FIG. 1(b), electronic components are placed at predetermined positions corresponding to the on-board electrodes 2. Further as shown in FIG. 1(c), the resin component of the present invention is subjected to the curing process, so as to fasten or tentatively fasten the electronic components 4 on the circuit board 1 by means of the cured resin composition 5.

When necessary, positions and orientations of the electronic components 4 fastened on the circuit board 1 are visually inspected as required at this stage. Items that have passed the inspection are sent to the next process (d) and items that have not passed the inspection are sent to the repairing process.

A flux 6 is applied to the circuit board 1 that have passed the inspection as shown in FIG. 1(d). Then as the circuit board 1 is dipped in molten solder, the on-board electrodes 2 and the leads of the electronic components mounted thereon are connected with each other by the solder 7. Immersion into the molten solder is usually carried out in the flow soldering connection process.

In the flow soldering connection process, the circuit board having the electronic components mounted thereon is dipped into the soldering material of molten state. Since the time required to dip the circuit board in the molten soldering material of 200 to 260° C. is about 5 to 20 seconds, heat quantity supplied from the molten solder to the circuit board and the resin composition is enough to soften the cured resin composition on the circuit board, but is not sufficient to change the form of the cured resin composition to another form wherein the resin composition can be taken off from the circuit board, for example gel-or liquid-form.

### Method for Producing Circuit Board

The method for producing a circuit board having electronic components fastened at predetermined positions thereof comprises processes of (i) supplying the resin composition to predetermined positions on the circuit board except for the electrodes and placing the electronic components to the predetermined positions, and (ii) fastening the electronic components on the circuit board by curing the resin composition through the application of temperatures up to 110° C. With this method for producing the circuit board, it is made possible to send items, even when failed to pass the inspection (inspection process E1) before flow soldering connection (NG), to the repairing process R1 (the recovering method provided by the present application) so as to recover useful circuit board and/or electronic components and return the recovered circuit board and/or electronic components via the recycling line RL1 to the mounting process. Thus the present process is useful as a part of the components utilization process. In addition, the circuit boards obtained with the present method also contribute to effective implementation of the components utilization process.

According to the method of mounting electronic components on the circuit board by flow soldering connection, it is made possible to send the circuit board, even when failed to pass the inspection (inspection process E1) (NG), to the repairing process so as to recover the circuit board and/or the electronic components and sort out useful ones (OK) from the circuit board and/or electronic components by the inspection (E3) return them to the mounting process. Thus the present process is useful as a part of the components utilization process. In addition, the circuit boards obtained with the present method also contribute to effective implementation of the components utilization process.

The circuit board having electronic components mounted thereon by using the resin composition of the present invention is, when determined to be off-specification products (NG) in the inspection (E1), for example, discharged from the assembling line and sent to the repairing process (R1). The circuit board sent to the repairing process is heated from around the normal temperature to a temperature not higher than 110° C. As a result, the cured resin composition that has glass transition point of or 100° C. lower, preferably 35 to 80° C. is softened. For the heating means in the repairing process, various means known to those skilled in the art such as conveyor means that passes through a heating zone, warm air blower or soldering iron may be used as long as it can heat the circuit board, the electronic components and/or the resin component to a temperature up to 110° C. Such means include soldering iron, thermocouple, means for heating through radiation including light energy such as infrared ray, heat ray, leaser beam, and means for heating through convection by blowing a temperature regulating gas such as warm air heater.

The softened resin composition has physical strength that has decreased from the properties related to elasticity in solid state after curing, and therefore can be handled as a material that shows ordinary viscoelasticity, for example a high polymer compound of gel state. As a result, the resin composition can be easily broken or torn off by holding the electronic component with a proper fixture such as tweezers or cutting pliers and lifting the electronic component either mechanically or by hand. In this way, one or more electronic components can be separated from the circuit board and recovered.

The inspection may be conducted before sending the circuit board having the electronic components mounted thereon to the flow soldering connection process, (E1), but may also be carried out after applying flow soldering connection to the circuit board having electronic components mounted thereon (E2). In the inspection conducted before sending the item to the flow soldering connection process, it is determined whether positions and orientations of the electronic components fastened on the circuit board are correct or not, which may be carried out visually by a human operator, but also can be carried out automatically by an apparatus having a pattern recognition program and the like. In the inspection conducted after the flow soldering connection, it is checked mainly to determine whether the mounting-completed circuit board shows predetermined electrical characteristics by using a test facility, since mounting of the circuit board has been completed by the time of this stage. These inspections are carried out as required depending on the type of electric appliance to be assembled. In case the heat curable resin composition of the present invention is used, the circuit board and the electronic components can exhibit good repairability in the inspection conducted either before or after the flow soldering connection process.

The heat curable resin composition of the present invention is useful in an application in which the electronic components are tentatively fastened on the circuit board during the mounting process. The circuit board obtained by tentatively fastening the electronic components on the circuit board may be sent to either the subsequent mounting process (S5) or to the repairing process (R1, R2), as an intermediate product in the producing process of the electric appliance.

In case the circuit board that has been subjected to flow soldering connection is sent to the repairing process (from E2 to line NG to R2), soldering connections between the circuit board and the electronic components can be broken by heating the solder connections by using a proper tool so as to melt the solder before heating to the softening temperature or simultaneously therewith.

The heat curable resin composition described above, due to the composition described previously, makes it possible to mount the electronic components on the circuit board while avoiding heating of the circuit board and the electronic components to a temperature exceeding 140° C. As a result, the electronic components can be mounted on the circuit board without causing deterioration of performance or damage of the electronic components even when the low-heat resistant component is used. In case the circuit board having the electronic components mounted thereon is sent to the repairing process that follows, the circuit board and/or the electronic components can be recovered substantially intact in the repairing process.

In case the resin composition is the heat curable resin composition described above, circuit board and/or electronic components that are useful can be recovered and the circuit board and/or the electronic components that have been recovered can be returned to the mounting process by sending the components to the repairing process even when the mounting-completed circuit board that has the electronic components fastened at predetermined positions thereof has failed to pass the inspection conducted before flow soldering connection. Therefore the heat curable resin composition is useful for assisting the utilization process for components. The circuit boards obtained by this method also contribute to the effective implementation of the utilization process for components.

In case the resin composition is the heat curable resin composition described above, the circuit board and/or the electronic components that are useful can be recovered and the circuit board and/or the electronic components that have been recovered can be returned to the mounting process by sending the components to the repairing process even when the mounting-completed circuit board has failed to pass the inspection conducted after the flow soldering connection. Therefore the heat curable resin composition is useful for assisting the utilization process for components. The circuit boards obtained by the present method also contribute to the effective implementation of the utilization process for components.

### Repairing Process

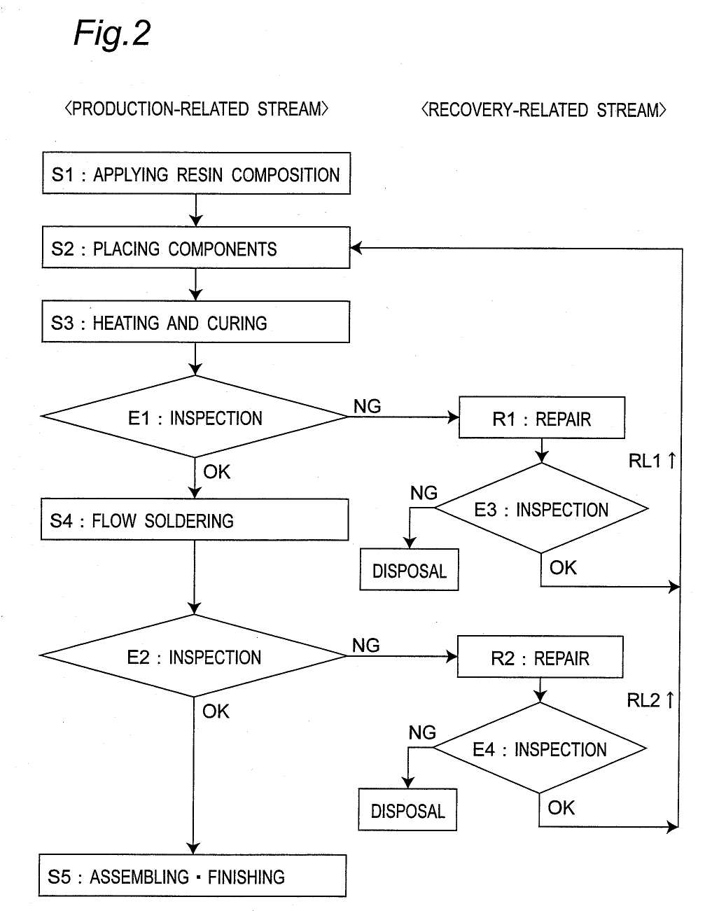

Now the repairing process (from R1 to E3 and/or from R2 to E4 in FIG. 2) in a preferred embodiment of the present invention will be described.

As an example, in a mid stage of the mounting process of control circuit board for DVD recorder, mounting-completed circuit board was taken out of a stage where 2125C chip-miniature transistor (QFP, 0.8 mm pitch, 64-pin) is tentatively fastened by means of an adhesive (the heat curable resin composition) on a printed circuit board (tentative fastening stage S3) and a stage where the printed circuit board was subjected to flow soldering connection (soldering process S4), and was subjected to the repairing processes R1 and R2 of the invention of the present application.

### EXAMPLE 1

The following operation was conducted on the circuit board in the tentative fastening stage, and both the circuit board and the miniature transistor were recovered without damage. The circuit board was placed on a workbench whereon a warm air heater capable of blowing air of 80° C. was put to adjoin therewith, and warm air was blown while measuring the temperature (T1) of the circuit board surface below the miniature transistor and the temperature (T2) of the resin composition with thermocouples. The resin composition was one prepared by mixing thiol-based curing agent, an organic-inorganic composite insulating filler and an imidazole-based curing accelerator to bisphenol A type epoxy resin.

The glass transition point had been determined to be about 42° C. by measuring with a dynamic viscoelasticity measuring instrument (manufactured by Seiko Instruments Inc.) in advance.

The resin composition was softened by blowing warm air to raise T2 to 42° C. or higher. T1 was 42° C. at this time.

It was easy to break the resin composition so as to separate the miniature transistor from the circuit board, by lifting the miniature transistor with tweezers.

The miniature transistor was verified to be normally usable by the predetermined inspection (E3) after removing the remainder of the resin composition by using ethanol (R1) (electronic components recovering process). The circuit board was also verified to be normally usable by the predetermined inspection (E3) after removing the remainder of the resin composition by using ethanol (R1) (electronic components recovering process). The miniature transistor and the circuit board were recycled to the mounting process (RL1 to S2).

### EXAMPLE 2

Assuming that the electronic components may have fault, the following operation was conducted on the circuit board in the tentative fastening stage so as to recover the circuit board without damage. The resin composition had the same composition as that of Example 1, with glass transition (Tg) point of 42° C. Temperature (T1) of the circuit board surface below the miniature transistor and the temperature (T2) of the resin composition were measured with thermocouples similarly to Example 1.

A soldering iron was pressed against the miniature transistor that was fastened on the circuit board by means of the resin composition and, when T2 reached 50° C., the miniature transistor was lifted with tweezers. T1 was 75° C. at this time. Similarly to Example 1, it was easy to break the resin composition so as to separate the miniature transistor from the circuit board.

Then the miniature transistor was sent to the electronic components recovering process, but was not recycled because functional abnormality was found in the miniature transistor (R1 to E3 to NG to disposal). The circuit board was sent to the circuit board recovering process and, after being verified to be normally usable, recycled to the mounting process (R1 to E3 to OK to RL1 to S2).

### EXAMPLE 3

The same circuit board as that of Example 1, taken out of the flow soldering connection process (S4), was processed in the repairing process (R2). The following operation was conducted on the circuit board in the soldering process, and both the circuit board and the miniature transistor were recovered without damage.

With leads of the miniature transistor surrounded with a copper braid, a soldering iron was applied to the leads to melt most of the solder deposited thereto so as to absorb the solder into the copper braid and remove it. Then the circuit board was placed on a workbench whereon a warm air heater capable of blowing air of 80° C. was put to adjoin therewith, and warm air was blown to melt the resin composition, while measuring the temperatures (T1 and T2).

Similarly to Example 1, it was easy to break the resin composition and separate the miniature transistor from the circuit board.

Then the miniature transistor was sent to the inspection process E4 to be verified for normal functionality, and was recycled to the mounting process (RL1 to S2). The circuit board was also sent to the inspection process E4 to be verified for normal functionality, and was recycled to the mounting process (RL1 to S2).

### EXAMPLE 4

The same circuit board as that of Example 3, taken out of the flow soldering connection process, was processed in the repairing process of the invention of the present application. The following operation was conducted on the circuit board in the soldering process, and the circuit board was recovered without damage.

With leads of the miniature transistor surrounded with a copper braid, a soldering iron was applied to the leads to melt most of the solder deposited thereto so as to absorb the solder into the copper braid and remove it. Then a soldering iron was pressed against the miniature transistor and, when T2 reached 50° C., the miniature transistor was lifted with tweezers. T1 was 75° C. at this time, and surface temperature of the miniature transistor was 105° C. Similarly to Example 3, it was easy to break the resin composition so as to separate the miniature transistor from the circuit board.

Then the miniature transistor was sent to the inspection process E4, but was not recycled because functional abnormality was found in the miniature transistor (R2 to E4 to NG to disposal). The circuit board was sent to the circuit board recovering process and was verified to be functionally normal, and was recycled to the mounting process (R2 to E4 to OK to RL2 to RL1 to S2).

Conditions for Examples of repairing and Examples of repairing conducted for comparison described above are shown in Table 3. In either of Examples where the heat curable resin composition of the present invention was used (Repair Examples 1, 2), it was possible to repair (remove) the electronic components under the conditions of circuit board surface temperature T1 of 110° C. or lower and resin composition temperature T2 of 110° C. or lower, within a duration of preferably 30 seconds, more preferably 15 seconds. In Examples where the heat curable resin composition of the Comparative Example was used (Repair Examples 3, 4), circuit board surface temperature T1 of 130° C. or higher and resin composition temperature T2 of 130° C. or higher were necessary to repair the electronic components. Circuit board surface temperature T1 and resin composition temperature T2, both 130° C. or higher, made it impossible to maintain the normal characteristics and recover (repair) the reusable electronic components (miniature transistor).

TABLE 3

| | | | Repair | Repair |
|---|---|---|---|---|
| | Repair | Repair | Example 3 | Example 4 |
| Resin | Example 1 | Example 2 | Comparative | Comparative |
| composition | Example 1 | Example 4 | Example 1 | Example 6 |
| Tg of resin | 42 | 42 | 151 | 104 |
| composition | | | | |
| (° C.) | | | | |
| Circuit board | 42 | 75 | 130 | 104 |
| surface | | | | |
| temperature | | | | |
| T1 (° C.) | | | | |
| Resin | 42 | 50 | 120 | 95 |
| composition | | | | |
| temperature | | | | |
| T2 (° C.) | | | | |
| Repairability | G | G | NG | NG |
| Processing | 10 | 15 | — | — |
| time | | | | |
| (seconds) | | | | |

With regard to the repairability in the Examples described in Table 3, repairability was evaluated as “Good (G)” when the component was recovered in normal state, and “No Good (NG)” when the recovered component showed malfunction or damage.

In most cases in which the repairing process is implemented, the circuit boards are considered to be usable without problem. Therefore, the repairing process of the present invention can be applied to substantially all the circuit boards by changing the means and time used in heating during the operations of the Examples described above in accordance with the glass transition point (Tg) of the resin composition.

Considering carrying out of the respective inventions of the present application, in the case of tentatively fastening electronic components to the circuit board in the mounting process, a heat curable resin composition containing 100 parts by weight of the epoxy resin (A), 30 to 200 parts by weight of the thiol-based curing agent (B), 5 to 200 parts by weight of the organic-inorganic composite insulating filler (C) and 0.5 to 20 parts by weight of the imidazole-based curing accelerator (D) is preferably used.

The following materials were used as the respective components.

Epoxy resin as a component (A): EPICOAT 828 (manufactured by Japan Epoxy Resins Co., Ltd.), (Bisphenol A type epoxy resin having an epoxy equivalent of 187)

Curing agent as a component (B): Trimethylolpropane tristhiopropionate (manufactured by Yodo Kagaku Co., Ltd.)

Organic-inorganic composite insulating filler as a component (C): AEROSIL 200 (manufactured by NIPPON AEROSIL CO., LTD.)

Curing accelerator as a component (D): Curezol 2MZA (manufactured by Shikoku Chemicals Corporation)

This heat curable resin composition can have a glass transition temperature (Tg) of 20° C. or higher, preferably 30° C. or higher, particularly preferably 35° C. or higher, and 105° C. or lower, preferably 100° C. or lower, particularly preferably 80° C. or lower after curing, and thus the present inventors have already confirmed that it is a resin composition which exhibits good repairability with respect to the present invention.

### INDUSTRIAL APPLICABILITY

The method for recovering circuit board and/or electronic components according to the first and second inventions of the present application, the method for recycling the circuit board and/or electronic components according to the third invention and the circuit board mounting method according to the fourth invention all make it possible to prevent wasteful disposal of the components and the circuit board, and therefore can be used in the production of various electric appliances. Particularly these are very useful in producing home electric appliances and industrial electric appliances that use electronic components of high unit prices, such as liquid crystal display, plasma display, DVD recorder and player, audio equipment, rice cooking jar, microwave oven and illumination equipment.

1-17. (canceled)

18. A heat curable resin composition comprising:
(A) 100 parts by weight a liquid epoxy resin,
(B) 30 to 200 parts by weight of the thiol-based curing agent,
(C) 5 to 200 parts by weight of the organic-inorganic composite insulating filler, and
(D) 0.5 to 20 parts by weight of the imidazole-based curing accelerator,
the heat curable resin composition having a curing temperature of 140° C. or less.

19. The heat curable resin composition according to claim 18, which has a glass transition point (Tg) of 20 to 120° C. after being cured.

20. The heat curable resin composition according to claim 18, which can be resoftened during the process of heating to 100° C. after cured.

21. The heat curable resin composition according to claim 18, wherein the thiol-based curing agent (B) is a compound selected from the group consisting of mercaptpropionic acid derivatives such as 3-mercaptopropionic acid, methoxybutyl mercaptopropionate, octyl mercaptopropionate, tridecyl mercaptopropionate, trimethylolpropane tristhiopropionate and pentaerythritol tetrakisthiopropionate; or thioglycol derivatives such as pentaerythritol tetrakisthioglycolate, trimethylolpropane tristhioglycolate and butanediol bisthioglycolate,
wherein the organic-inorganic composite insulating filler (C) is a compound selected from the group consisting of those obtained by surface-treating inorganic fillers such as alumina, silica and talc with an organosilicone, organotitanium or organoaluminum compound; and
wherein the imidazole-based curing accelerator (D) is a compound selected from the group consisting of derivatives of 2-methylimidazole and 2-ethyl 4-methylimidazole, or a trimellitate or isocyanurate of the imidazole derivatives.

22. The heat curable resin composition according to claim 19, wherein the thiol-based curing agent (B) is a compound selected from the group consisting of mercaptpropionic acid derivatives such as 3-mercaptopropionic acid, methoxybutyl mercaptopropionate, octyl mercaptopropionate, tridecyl mercaptopropionate, trimethylolpropane tristhiopropionate and pentaerythritol tetrakisthiopropionate; or thioglycol derivatives such as pentaerythritol tetrakisthioglycolate, trimethylolpropane tristhioglycolate and butanediol bisthioglycolate,
wherein the organic-inorganic composite insulating filler (C) is a compound selected from the group consisting of those obtained by surface-treating inorganic fillers such as alumina, silica and talc with an organosilicone, organotitanium or organoaluminum compound; and
wherein the imidazole-based curing accelerator (D) is a compound selected from the group consisting of derivatives of 2-methylimidazole and 2-ethyl 4-methylimidazole, or a trimellitate or isocyanurate of the imidazole derivatives.

23. A method for mounting electronic components on a circuit board by flow soldering connection, comprising the processes of:
(i) supplying the resin composition according to claim 18 to predetermined positions on the circuit board except for electrodes and placing the electronic components in correspondence thereto,
(ii) fastening the electronic components on the circuit board by curing the resin composition through the application of temperatures up to 110° C., and
(iii) supplying the circuit board obtained in the process (ii) to a flow soldering connection line so as to complete the flow soldering connection.

24. A method for recovering electronic components and circuit boards from mounting-completed circuit boards having the electronic components fastened thereon by means of a cured resin composition, comprising the processes of:
(a) softening a resin composition while heating the mounting-completed circuit board having the electronic components fastened thereon in a temperature range from around the normal temperature to 110° C. or lower;
(b) separating the electronic components from the circuit board by using a picking up tool; and
(c) sending the circuit board obtained in the process (b) to a circuit board recovering process; and/or a process of sending the electronic components separated in the process (b) to an electronic components recovering process.

25. The method for recovering the electronic components and the circuit board according to claim 24 using a circuit board, onto which board the electronic components were fastened by means of a resin composition that is in glass state when cured and shows rubber-like elasticity when softened by being heated to a glass transition point (Tg) thereof or higher.

26. The method for recovering the electronic components and the circuit board according to claim 25, wherein the resin composition shows dynamic viscoelasticity in its glass-like region at around the normal temperature in cured state, and softens when heated to a temperature in a range from the glass transition point (Tg) of the resin composition up to 110° C. so as to show a storage elastic modulus in a range from 10 MPa to 1,000 MPa.

27. The method for recovering the electronic components and the circuit boards according to claim 24, that uses circuit boards determined to be off-specification products by inspection at any stage in an circuit board mounting process that employs flow soldering connection.

28. The method for recovering the electronic components and circuit boards according to claim 24, which method uses a heat curable resin composition comprising: (A) 100 parts by weight a liquid epoxy resin, (B) 30 to 200 parts by weight of the thiol-based curing agent, (C) 5 to 200 parts by weight of the organic-inorganic composite insulating filler, and (D) 0.5 to 20 parts by weight of the imidazole-based curing accelerator, the heat curable resin composition having a curing temperature of 140° C. or less.

29. The method for recovering the electronic components and circuit boards according to claim 28, which method uses a heat curable resin composition which has a glass transition point (Tg) in a range from 20 to 120° C. after being cured.

30. An integrated method for mounting a circuit board, comprising:
(o) a circuit board mounting process to subject a circuit board to a flow soldering connection line, wherein electronic components were fastened onto the circuit board with using a resin composition based on epoxy resin composition;
(p) a sorting process for sorting out circuit boards determined to be off-specification products by inspection in any process of the mounting process and discharging the off-specification products from the mounting process;
(q) a recovering process to separate and recover the electronic components from the circuit board, by heating the circuit boards discharged from the sorting process (p) at a temperature range from the glass transition point (Tg) of the resin composition to a temperature up to 110° C., thereby softening the resin composition; and
(r) a recycling process to apply the electronic components and/or the circuit boards recovered from the recovering process (q) to the circuit board mounting process.

31. The integrated method for mounting a circuit board according to claim 30, which method uses a circuit board, onto which board electronic components were fastened by means of a resin composition that is in glass state when cured and shows rubber-like elasticity when softened by being heated to a glass transition point (Tg) thereof or higher.

32. The integrated method for mounting a circuit board according to claim 31, wherein the resin composition shows dynamic viscoelasticity in the glass-like region at around the normal temperature in cured state, and softens when heated to a temperature in a range from the glass transition point (Tg) of the resin composition up to 110° C. so as to show a storage elastic modulus in a range from 10 MPa to 1,000 MPa.

33. The integrated method for mounting a circuit board according to claim 30, which method uses circuit boards determined to be off-specification products by inspection at any stage in the circuit board mounting process that employs flow soldering connection.

34. The integrated method for mounting a circuit board according to claim 30, which method uses a heat curable resin composition comprising: (A) 100 parts by weight a liquid epoxy resin, (B) 30 to 200 parts by weight of the thiol-based curing agent, (C) 5 to 200 parts by weight of the organic-inorganic composite insulating filler, and (D) 0.5 to 20 parts by weight of the imidazole-based curing accelerator, the heat curable resin composition having a curing temperature of 140° C. or less.

35. The integrated method for mounting a circuit board according to claim 34, which method uses a heat curable a heat curable resin composition which has a glass transition point (Tg) of 20 to 120° C. after being cured.
